(19) United States
(12) Patent Application Publication
(10) Pub. No.: US 2026/0126398 A1
(43) Pub. Date: May 7, 2026

(54) IMAGING DEVICE WITH TILTABLE MIRROR FOR INTERNAL SURFACE OF CYLINDRICAL BATTERY PRODUCTS

(71) Applicant: ENSCAPE CO., LTD., Yongin-si (KR)

(72) Inventors: Seong Gi KIM, Asan-si (KR); Ji Man RYU, Suwon-si (KR); In Ho KA, Seongnam-si (KR); Sang Jin CHOI, Seongnam-si (KR)

(21) Appl. No.: 19/378,939

(22) Filed: Nov. 4, 2025

(30) Foreign Application Priority Data
Nov. 5, 2024 (KR) 10-2024-0155285
Sep. 5, 2025 (KR) 10-2025-0126662

(51) Int. Cl. G01N 21/88; G01N 21/954; G02B 26/08; H01M 10/04

(52) U.S. Cl. CPC G01N 21/8806; G01N 21/954; G02B 26/0816; H01M 10/04; G01N 2201/0636

(57) ABSTRACT

Disclosed is an imaging device with a tiltable mirror for an internal surface of cylindrical battery products, the imaging device including: a transfer module configured to transfer a cylindrical battery product, which is in an upright posture with its top side open, to an imaging position; a camera module positioned above the imaging position and configured to capture an image of the cylindrical battery product transferred to the imaging position; and an internal-surface reflection mirror module positioned between the imaging position and the camera module and configured to reflect the internal surface of the cylindrical battery product.

### CROSS REFERENCE TO RELATED APPLICATION

Priority to Korean Patent Application No. 10-2024-0155285 filed on Nov. 5, 2024 and No. 10-2025-0126662 filed on Sep. 5, 2025, the entire disclosure of which are incorporated by reference herein, are claimed.

### BACKGROUND OF THE INVENTION

### Field of the Invention

The disclosure relates to an imaging device with a tiltable mirror for inspecting the internal surface of cylindrical battery products. The present application is the result of the “materials and components technology development program (R&D)” supervised by the Korea Planning & Evaluation Institute of Industrial Technology (KEIT), under the project (titled “Development of an Integrated Optical System for Inspection and Measurement and AI-Based Vision Inspection System for Next-Generation Cylindrical Batteries (4680 to 46200 types), and Project No. RS-2024-00418621).

### Description of the Related Art

Secondary batteries refer to batteries that convert chemical energy into electrical energy to supply power and, when discharged, receive external power and convert electrical energy back into chemical energy for storage. With the advancement of electronic devices, the secondary batteries are being applied to various devices in a wide range of fields. These secondary batteries are produced in a variety of forms, and among them, commonly used cylindrical batteries are still widely used today.

Cylindrical batteries with defects such as dents, scratches, or stains on the surface are classified as defective and discarded before final shipment to proactively eliminate the risk of safety incidents caused by the defects. Therefore, battery manufacturers perform vision inspections on cylindrical batteries before final delivery to preemptively identify defective ones.

As the amount of power required for electronic devices has recently increased, cylindrical batteries are also growing in size. Specifically, the batteries with diameters of approximately 46 mm and lengths ranging from 80 mm to 130 mm have emerged. In terms of surface inspection, larger cylindrical batteries are more difficult to inspect on the internal surface than on the external surface.

As a concrete example of conventional surface inspection, the internal surface of the cylindrical battery was imaged by moving the cylindrical battery relative to a camera placed at a certain distance directly above the cylindrical battery, with a mirror positioned in the optical path of the camera to reflect the internal surface. Therefore, as the length of the cylindrical battery increases, the height at which the camera is installed increases, and the distance the battery moves up and down also increases, thereby resulting in a corresponding increase in the overall size of the optical system.

In addition, the increase in the length of a cylindrical battery product causes a bottom portion of the cylindrical battery product to be positioned deeper. Therefore, to image a lower portion of the internal surface, the mirror needs to be tilted to be nearly vertical. The mirror tilted in this way narrows a viewing angle for inspecting the defects on the lower portion of the internal surface, thereby causing the defects to appear smaller in a detected image and hindering the ability to detect the defects. Nevertheless, it is unavoidable to maintain the foregoing tilt angle of the mirror in order to image the lower portion of the internal surface, and thus the conventional inspection imaging has been performed by using the mirror tilted nearly vertical to reflect the internal surface from top to bottom.

### SUMMARY OF THE INVENTION

An aspect of the disclosure is to provide an optical system capable of maintaining a certain level of detection capability or higher for cylindrical battery products, which have a high aspect ratio (i.e., a ratio of length to diameter), while minimizing changes in the volume thereof.

Another aspect of the disclosure is to provide an optical system capable of capturing images at optimal angles for various vertical positions on the internal surface of cylindrical battery products based on tilt adjustment of the mirror.

The problems of the disclosure are not limited to the aforementioned problems, and other problems not mentioned above may become apparent to those skilled in the art from the following description.

According to an embodiment of the disclosure, an imaging device with a tiltable mirror for an internal surface of cylindrical battery products includes: a transfer module configured to transfer a cylindrical battery product, which is in an upright posture with its top side open, to an imaging position; a camera module positioned above the imaging position and configured to capture an image of the cylindrical battery product transferred to the imaging position; and an internal-surface reflection mirror module positioned between the imaging position and the camera module and configured to reflect the internal surface of the cylindrical battery product.

The internal-surface reflection mirror module may include: a plurality of mirrors arranged around a height axis vertically passing through the imaging position; and a mirror angle adjuster configured to adjust an angle formed by each of the mirrors with respect to the height axis.

Each of the mirrors may be provided to have a tilted shape to protrude further toward the height axis as being positioned closer to a lower end.

The mirror angle adjuster may be configured to adjust each of the mirrors from a first angle to a second angle or from the second angle to the first angle upon the cylindrical battery product being transferred to the imaging position.

The first angle may be an angle at which the mirror reflects a lower portion on the internal surface of the cylindrical battery product, and the second angle may be an angle at which the mirror reflects an upper portion on the internal surface of the cylindrical battery product.

The imaging device may further include a detector sensor configured to detect the cylindrical battery product transferred to the imaging position.

The imaging device may further include a lifting module configured to change relative distances between the internal-surface reflection mirror module and the transfer module.

The lifting module may include a stage formed to move up and down and configured to allow the cylindrical battery product located at the imaging position to be seated thereon.

The lifting module may include a mirror lifting actuator configured to adjust the height of the internal-surface reflection mirror module.

The lifting module may further include a camera lifting actuator configured to adjust the height of the camera module.

The imaging device may further include a coaxial lighting module arranged between the internal-surface reflection mirror module and the camera module, and configured to irradiate light in a direction coaxial with an imaging direction of the camera module.

Other details of the disclosure are included in the detailed description and the accompanying drawings.

### BRIEF DESCRIPTION OF THE DRAWINGS

FIG. 1 is a schematic view of an imaging device with a tiltable mirror for the internal surface of cylindrical battery products according to an embodiment of the disclosure.

FIG. 2 is a conceptual diagram of a lifting module according to an embodiment of the disclosure, which includes a camera lifting actuator, a lighting lifting actuator, and a mirror lifting actuator.

FIG. 3 is a schematic top view of an internal-surface reflection mirror module according to an embodiment of the disclosure, which is viewed from above.

FIG. 4 is a diagram for describing operations of a mirror angle adjuster according to an embodiment of the disclosure.

FIG. 5 is a diagram illustrating a state in which a mirror according to an embodiment of the disclosure is at a first angle.

FIG. 6 is a diagram illustrating a state in which the mirror shown in FIG. 5 is tilted from the first angle to an angle closer to a second angle.

FIG. 7 is a diagram illustrating a state in which a mirror is tilted to the first angle for a relatively long cylindrical battery product.

FIG. 8 is a diagram illustrating a state in which a mirror is tilted to the first angle for a relatively short cylindrical battery product.

FIG. 9 is a diagram illustrating a state in which a mirror is tilted to the first angle for a cylindrical battery product having a larger diameter than the cylindrical battery product shown in FIG. 7.

FIG. 10 is a conceptual diagram of an imaging device with a tiltable mirror for the internal surface of cylindrical battery products according to another embodiment of the disclosure.

### DETAILED DESCRIPTION OF THE INVENTION

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

The term “cylindrical battery product” mentioned below may collectively refer to a finished cylindrical battery or a semi-finished product, such as a cylindrical battery can before jelly roll insertion. In this case, the cylindrical battery may refer to a battery with a curved side surface and circular top and bottom surfaces.

Further, upper/lower/left/right/front/rear directions mentioned below are merely used to describe the disclosure with respect to a specific reference point, and the disclosure is not construed as being limited to such directions. In other words, it is apparent that, in actual use, the installation and use may be achieved in directions different from those set forth herein, and the disclosure should be interpreted as including such embodiments.

Meanwhile, the term “reflect” mentioned below may refer to that an image of one object appears on another object that reflects light.

Further, the term “upright posture” of the cylindrical battery product may refer to a state in which the top and bottom surfaces of the cylindrical battery product are arranged along a height axis, and the circular bottom surface of the cylindrical battery product is oriented parallel to the ground.

Below, an imaging device with a tiltable mirror for the internal surface of cylindrical battery products according to an embodiment of the disclosure will be described with reference to the accompanying drawings.

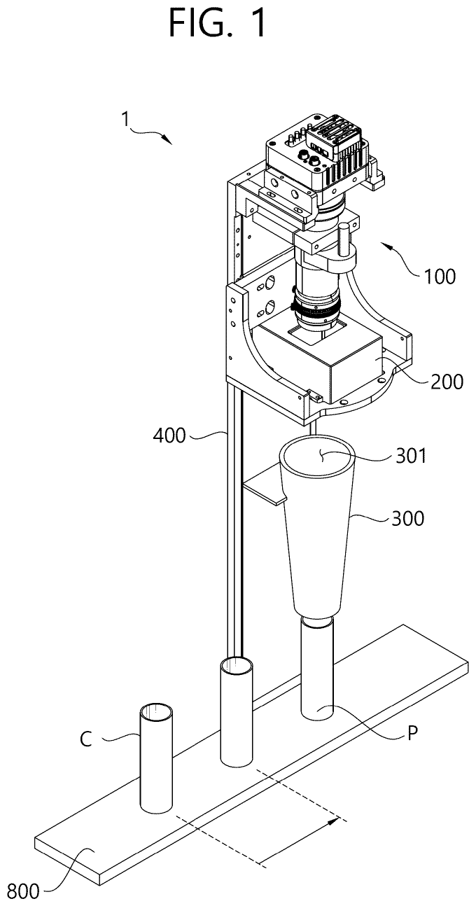

First, FIG. 1 is a schematic view of an imaging device with a tiltable mirror for the internal surface of cylindrical battery products according to an embodiment of the disclosure. As shown in FIG. 1, the imaging device 1 with the tiltable mirror for inspecting the internal surface of cylindrical battery products according to an embodiment of the disclosure may include a camera module 100, a coaxial lighting module 200, an internal-surface reflection mirror module 300, a support 400, and a transfer module 800.

The camera module 100 is positioned above an imaging position P and captures an image of a cylindrical battery product C transferred to the imaging position P. For example, the camera module 100 may be provided with one or more area scan cameras.

The coaxial lighting module 200 is arranged between the camera module 100 and the internal-surface reflection mirror module 300 and irradiates light in a direction coaxial with an imaging direction of the camera module 100. For example, the coaxial lighting module 200 may irradiate light parallel to the optical axis of the camera module 100. Further, the coaxial lighting module 200 may have an opening formed to penetrate a center portion thereof in a height direction to have the same central axis as the camera module 100 so that the camera module 100 can capture the images of the cylindrical battery product C and the internal-surface reflection mirror module 300. The camera module 100 can capture the images of the cylindrical battery product C and the internal-surface reflection mirror module 300 located below the coaxial lighting module 200 through the opening aligned coaxially.

The internal-surface reflection mirror module 300 is positioned between the imaging position P and the camera module 100 and is configured to reflect the internal surface of the cylindrical battery product C. That is, the internal-surface reflection mirror module 300 is positioned so that internal surface of the cylindrical battery product C can be viewed through a reflective surface when view from the camera module 100. The internal-surface reflection mirror module 300 may be positioned directly above the cylindrical battery product C located at the imaging position P, and aligned coaxially with the central axis (i.e., the vertical axis at the imaging position) of the cylindrical battery product C. In this case, the internal-surface reflection mirror module 300 may include an observation hole 301 formed at the center thereof and positioned coaxially with the camera module 100. The camera module 100 can capture both an image formed on the internal-surface reflection mirror module 300 and the bottom surface of the cylindrical battery product C observed through the observation hole 301.

The support 400 may be a frame that supports the camera module 100, the coaxial lighting module 200, and the internal-surface reflection mirror module 300 so that they have the same central axis. The camera module 100, the coaxial lighting module 200, and the internal-surface reflection mirror module 300 may each be slidably coupled to the support 400 in the height direction.

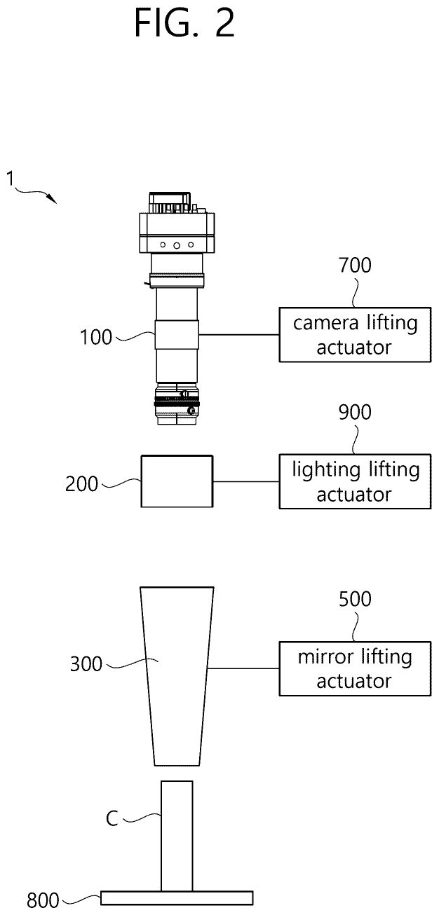

Although not shown, a lifting module may be configured to change relative distances between the transfer module 800 and one or more of the camera module 100, the coaxial lighting module 200 and/or the internal-surface reflection mirror module 300 based on a sliding movement structure of each component relative to the support 400. In this regard, description will be made with reference to FIG. 2.

The transfer module 800 is provided to transfer the cylindrical battery product C, which is in an upright posture with its top side open, to the imaging position P. For example, the transfer module 800 may be provided in the form of a conveyor. In this case, the transfer module 800 may operate to transfer the cylindrical battery product C by a predetermined distance at a time. For example, a plurality of cylindrical battery products C may be arranged on the transfer module 800 at regular intervals, and the transfer module 800 may advance the cylindrical battery product C by a predetermined distance at a time and then stop for a moment. Referring to FIG. 1, once the transfer module 800 operates, the cylindrical battery product C may advance by the distance indicated by the arrow in FIG. 1.

Below, the lifting module according to an embodiment of the disclosure will be described with reference to FIG. 2. FIG. 2 is a conceptual diagram of the lifting module according to an embodiment of the disclosure, which includes a camera lifting actuator, a lighting lifting actuator, and a mirror lifting actuator.

As shown in FIG. 2, the lifting module according to an embodiment of the disclosure may include a camera lifting actuator 700, a lighting lifting actuator 900, and a mirror lifting actuator 500.

The camera lifting actuator 700 may be provided as a driving unit that moves the camera module 100 mounted on the support up and down in the height direction. The camera lifting actuator 700 only needs to be provided as a driving device capable of moving the camera module 100 in the height direction, and is not limited to any specific configuration. For example, the camera lifting actuator 700 may include a motor, an actuator, etc. to move the camera module 100 up and down.

The lighting lifting actuator 900 may be provided as a driving unit that moves the coaxial lighting module 200 mounted on the support up and down in the height direction. Similarly, the lighting lifting actuator 900 only needs to be provided as a driving device capable of moving the coaxial lighting module 200 in the height direction, and is not limited to any specific configuration. For example, the lighting lifting actuator 900 may include a motor, an actuator, etc. to move the coaxial lighting module 200 up and down.

The mirror lifting actuator 500 may be provided as a driving unit that moves the internal-surface reflection mirror module 300 mounted on the support up and down in the height direction. Similarly, the mirror lifting actuator 500 only needs to be provided as a driving device capable of moving the internal-surface reflection mirror module 300 in the height direction, and is not limited to any specific configuration. For example, the mirror lifting actuator 500 may include a motor, an actuator, etc. to move the internal-surface reflection mirror module 300 up and down.

A user may operate the camera lifting actuator 700, the lighting lifting actuator 900, and the mirror lifting actuator 500 to move the camera module 100, the coaxial lighting module 200, and the internal-surface reflection mirror module 300 to appropriate heights, respectively, in advance according to the specifications of the cylindrical battery product being transferred by the transfer module 800.

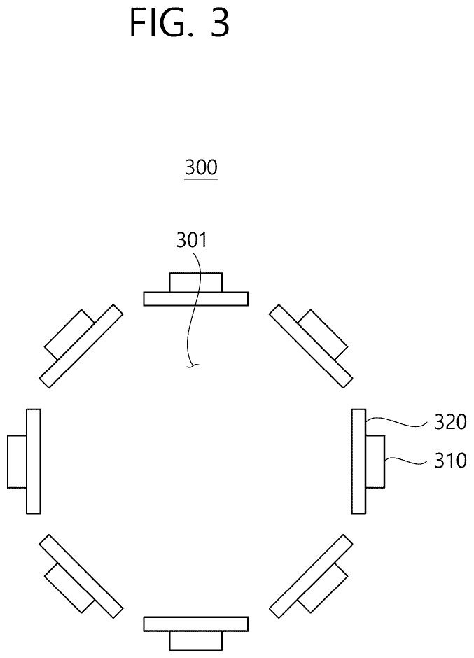

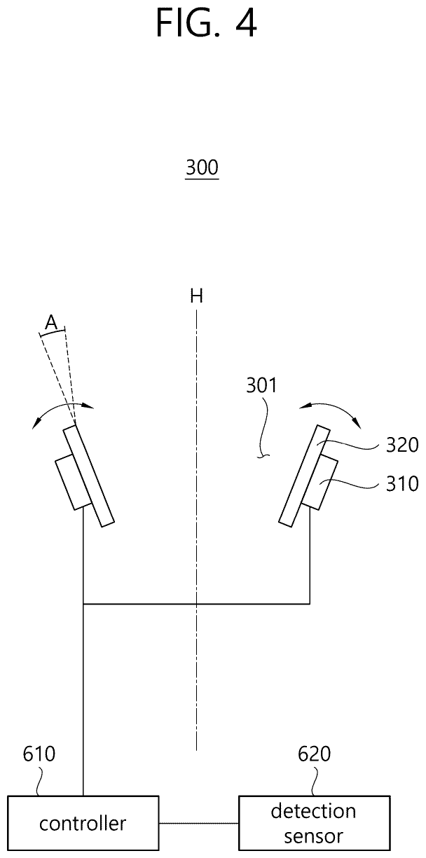

Below, the configuration of the internal-surface reflection mirror module according to an embodiment of the disclosure will be described with reference to FIGS. 3 and 4. FIG. 3 is a schematic top view of the internal-surface reflection mirror module according to an embodiment of the disclosure, which is viewed from above. In this regard, FIG. 4 is a diagram for describing operations of a mirror angle adjuster according to an embodiment of the disclosure.

As shown in FIGS. 3 and 4, the internal-surface reflection mirror module 300 according to an embodiment of the disclosure may include a plurality of mirrors 320, and a mirror angle adjuster 310 mounted on each of the mirrors 320.

The plurality of mirrors 320 may be arranged at equal intervals along a circular trajectory centered around a height axis H vertically passing through the imaging position. Each mirror 320 has a reflective surface facing the observation hole 301, so that a back portion thereof can be tiltably connected to the mirror angle adjuster 310. In the internal-surface reflection mirror module 300, the observation hole 301 may be defined as a space between the mirrors 320, and the reflective surface serves as an inner wall surrounding the outer edge of the observation hole 301. In this case, each reflective surface of the mirror 320 is formed as a fully coated total reflection mirror, thereby reflecting all incident light. The light reflected from the total reflection mirror is used in the imaging of the camera module.

The mirrors 320 may be arranged at regular intervals around the vertical axis H passing through the imaging position. Although eight mirrors 320 are shown in FIG. 3, there is no limit to the number of mirrors. That is, the number and shape of the mirrors 320 are not limited as long as they can surround the observation hole 301. However, the number of mirrors 320 may be eight or more. In this case, the portions of the cylindrical battery product respectively reflected by the neighboring mirrors 320 may partially overlap.

Meanwhile, the mirror 320 may having a tilted shape to protrude further toward the height axis H as it is positioned closer to the lower end. With this shape, the observation hole 301 may have a wider width at the top than at the bottom. The tilt of the mirror 320 allows the internal surface of the cylindrical battery product located on the opposite side of the mirror 320 to be reflected on the reflective surface of the mirror 320 when observed from the position of the camera module 100.

The mirror angle adjuster 310 may adjust the angle formed by the reflective surface of the mirror 320 with respect to the height axis H vertically passing through the imaging position. To this end, the mirror angle adjuster 310 may include a frame connected to the back of the mirror 320, and a motor, actuator, etc. for tilting the frame. In this case, the mirror angle adjusters 310 respectively connected to the mirrors 320 may be synchronized with each other to operate together. As a result, all the mirrors 320 may have the same or similar angle with respect to the vertical axis H passing through the imaging position.

Meanwhile, the mirror angle adjuster 310 may adjust the tilt angle of the mirror 320 within a predetermined angle range A. In this case, the upper and lower limits of the predetermined angle range A will be referred to as the maximum angle and the minimum angle, respectively. The maximum angle may be defined as an angle at which the reflective surface of the mirror 320 forms the smallest angle with respect to the height axis H, and the minimum angle may be defined as an angle at which the reflective surface of the mirror 320 forms the largest angle with respect to the height axis H. In other words, the maximum angle corresponds to an angle that is nearly perpendicular to the ground, and the minimum angle corresponds to the smallest angle that the mirror 320 can form with respect to the ground.

Meanwhile, a first angle and a second angle may be present between the maximum angle and the minimum angle. The first angle and the second angle may be defined according to the specifications of the cylindrical battery product located at the imaging position. Here, the first angle refers to an angle at which the mirror 320 reflects a lower portion on the internal surface of the cylindrical battery product, and the second angle refers to an angle at which the mirror 320 reflects an upper portion on the internal surface of the cylindrical battery product.

A controller 610 for controlling the mirror angle adjuster 310 may receive information about the specifications of the cylindrical battery product to be currently inspected, which is input by a user in advance, and identify the first angle and the second angle corresponding to the input specifications. Thereafter, the controller 610 controls the mirror angle adjuster 310 to change the angle of the mirror 320 gradually from the first angle to the second angle or from the second angle to the first angle.

In this case, whether an initial angle is set to the first angle or the second angle may be determined according to a user's convenience. Further, the mirror angle adjuster 310 may adjust the mirror 320 to return to the initial angle and enter a standby mode before the first cylindrical battery product is moved to the imaging position.

The controller 610 may be configured to control the mirror angle adjuster 310 to initiate an angle adjustment operation for the mirror 320 when the cylindrical battery product reaches the imaging position. To this end, according to an embodiment of the disclosure, a detection sensor 620 may be provided to detect whether the cylindrical battery product has reached the imaging position.

The detection sensor 620 may be configured to detect the cylindrical battery product transferred to the imaging position. For example, the detection sensor 620 may be an optical sensor arranged to detect the cylindrical battery product located at the imaging position. In this case, the detection sensor 620 may include a light emitter that emits light toward the surface of the cylindrical battery product located at the imaging position, and a light receiver that normally receives light from the light emitter. Normally, light emitted from the light emitter is received in the light receiver. However, when the cylindrical battery product is moved to the imaging position, the light is blocked by the surface of the cylindrical battery product and does not reach the light receiver. When the light receiver does not detect the light, the detection sensor 620 recognizes that the cylindrical battery product is located at the imaging position and transmits a detection signal to the controller 610. The controller 610 that receives the detection signal transmits a control signal to each of the mirror angle adjusters 310, and each of the mirror angle adjusters 310 that receive the control signal changes the angle of the connected mirror 320 from the first angle to the second angle or from the second angle to the first angle.

After the mirror angle adjuster 310 changes the angle of the mirror 320, the controller 610 may control the mirror angle adjuster 310 to return the mirror 320 to the initial angle while the next cylindrical battery product is moved to the imaging position. Alternatively, the controller 610 may control the mirror angle adjuster 310 to maintain the changed angle of the mirror 320 (e.g., the second angle when the initial angle is the first angle, or vice versa), which has been changed from the initial angle during the imaging process of the previous cylindrical battery product. In this case, the controller 610 may control the mirror angle adjuster 310 to return the mirror 320 from the changed angle back to the initial angle when the next cylindrical battery product is moved to the imaging position. Meanwhile, the camera module may capture the entire internal surface of the cylindrical battery product located at the imaging position while the angle of the mirror 320 is changed from the first angle to the second angle or vice versa.

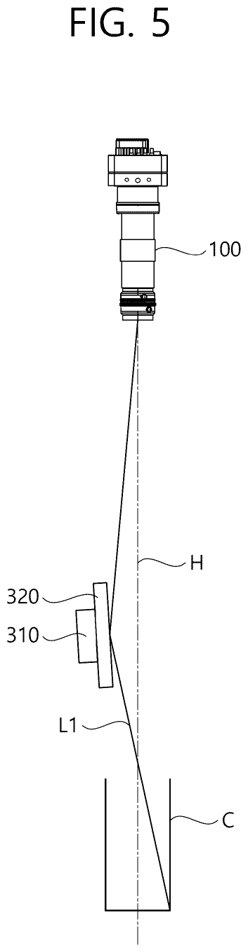

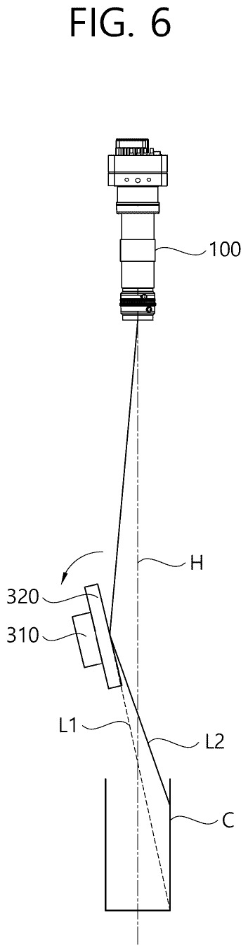

With reference to FIGS. 5 and 6, the following describes how the imaging device with the tiltable mirror for inspecting the internal surface of cylindrical battery products according to an embodiment of the disclosure captures the images of the internal surface.

FIG. 5 is a diagram illustrating a state in which one of the mirrors according to an embodiment of the disclosure is at the first angle. In this regard, FIG. 6 is a diagram illustrating a state in which the mirror shown in FIG. 5 is tilted from the first angle to an angle closer to the second angle. In this case, FIGS. 5 and 6 schematically show the optical path and the like in a reduced scale of the system for ease of understanding due to limitations in paper size. However, the light is totally reflected at the mirror 310, and the angle of incidence is equal to the angle of reflection.

As shown in FIGS. 5 and 6, according to one embodiment of the disclosure, a portion of the cylindrical battery product C, which will be reflected, may be changed by adjusting the angle of the mirror 320.

In this case, referring to FIG. 5, in order to reflect a lower portion of the cylindrical battery product C, the mirror 320 should to be positioned in a posture that is nearly perpendicular to the ground. In contrast, referring to FIG. 6, the higher the portion of the internal surface to be reflected, the smaller the angle of the mirror 320 with respect to the ground becomes. In this case, when comparing light L1 reflected from the lower portion of the cylindrical battery product C through the mirror 320 and light L2 reflected from the upper portion of the cylindrical battery product C through the mirror 320, the light L2 reflected from the upper portion has a larger angle with respect to the internal surface of the cylindrical battery product C than the light L1 reflected from the lower portion.

This difference allows the camera module 100 to have a better viewing angle in FIG. 6 than in FIG. 5. Here, the viewing angle may refer to the angle of the camera module with respect to a subject. In general, the camera may capture a clear image of a subject when facing the subject, but the shape of the subject in the image becomes distorted as the viewing angle becomes more oblique to the subject. Considering this, it can be seen that the optical path L2 for capturing the image of the upper portion in FIG. 6 has a better viewing angle than the optical path L1 for capturing the image of the lower portion in FIG. 5.

In the disclosure, this imaging method according to the disclosure has at least the following advantages.

First, when the cylindrical battery product C is transferred to the imaging position, it is possible to capture the image of the entire internal surface by adjusting only the angle of the mirror 320, thereby minimizing the driving structure of the entire optical system, and thus minimizing the volume of the optical system.

Further, while the lower portion of the cylindrical battery product C is inspected with a viewing angle sufficient to secure a minimum detection capability, higher positions of the cylindrical battery product C are inspected with a greater viewing angle, thereby providing the advantage of detecting defects in the upper portion, which were conventionally difficult to detect.

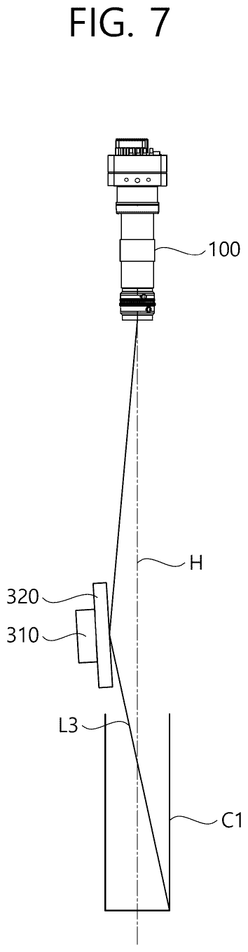

Hereinafter, with reference to FIGS. 7 to 9, it will be described how the imaging device with the tiltable mirror for inspecting the internal surface of cylindrical battery products according to an embodiment of the disclosure is compatible with cylindrical battery products of different specifications.

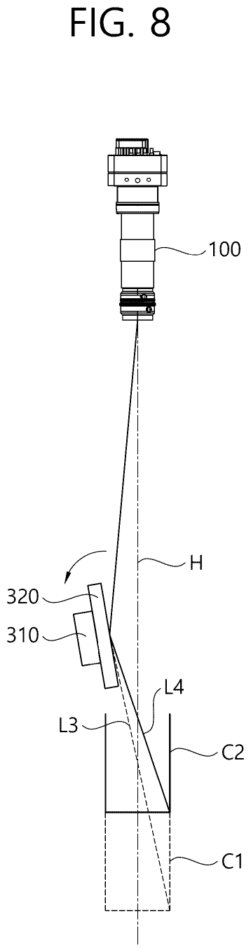

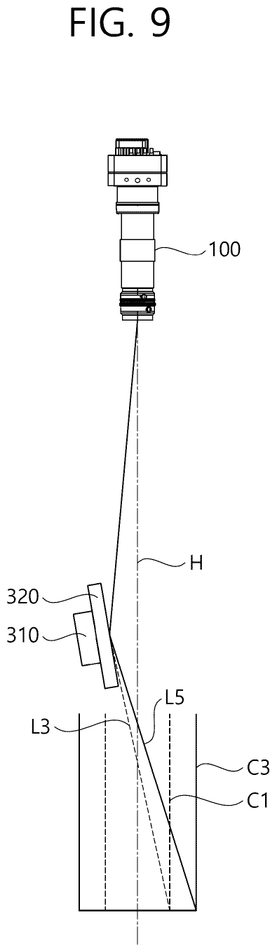

FIG. 7 is a diagram illustrating a state in which one of the mirrors is tilted to the first angle for a relatively long cylindrical battery product. On the other hand, FIG. 8 is a diagram illustrating a state in which one of the mirror is tilted to the first angle for a relatively short cylindrical battery product. Further, FIG. 9 is a diagram illustrating a state in which one of the mirrors is tilted to the first angle for a cylindrical battery product having a larger diameter than the cylindrical battery product shown in FIG. 7.

In this case, the relative heights of other components for each of the cylindrical battery products C1, C2 and C3 may be adjusted by the lifting module.

First, referring first to FIG. 7 and FIG. 8, for the inspection of the relatively short cylindrical battery product C2, the camera module 100, the internal-surface reflection mirror module, and the coaxial lighting module may be moved down by difference in length. As a result, regardless of the lengths of the cylindrical battery products C1 and C2, the relative distances between the cylindrical battery product C1 or C2 and the camera module 100, the internal-surface reflection mirror module, and the coaxial lighting module may be constant.

Ultimately, considering the difference in length between the battery products C1 and C2, the bottom of the short cylindrical battery product C2 coincides with the height of a middle portion of the long cylindrical battery product C1, and is therefore considered the same as the middle portion of the cylindrical battery product C1 from the perspective of the other components. Therefore, based on the same logic as described with reference to FIGS. 5 and 6, the mirror 320 of FIG. 8 has a smaller angle with respect to the ground than the mirror 320 of FIG. 7. Further, an angle of an optical path L4 for capturing an image of the bottom of the short cylindrical battery product C2 with respect to the inner surface of the cylindrical battery products C1 and C2 is greater than that of an optical path L3 for capturing an image of the bottom of the long cylindrical battery product C1, and thus the viewing angle in FIG. 8 is larger than that in FIG. 7.

Therefore, according to an embodiment of the disclosure, the first angle or the second angle may be set to maximize inspection efficiency depending on the length of the cylindrical battery products C1, C2 and C3. In particular, the shorter the cylindrical battery product, the greater the visibility of defective areas.

Below, with continued reference to FIG. 7 and FIG. 9, an angle of the mirror 320 with respect to the ground when capturing an image of the bottom of the cylindrical battery product C3 having a large diameter is smaller than an angle of the mirror 320 with respect to the ground when capturing an image of the bottom of the cylindrical battery product C1 having a small diameter. Therefore, based on the same logic as described above, an angle of an optical path L5 for capturing the image of the bottom of the cylindrical battery product C3 having the large diameter with respect to the inner surface of the cylindrical battery products C1 and C3 is greater than that of the optical path L3 for capturing the image of the bottom of the cylindrical battery product C1 having the small diameter, and thus the viewing angle in FIG. 9 is larger than that in FIG. 7.

Therefore, according to an embodiment of the disclosure, the first angle or the second angle may be set to maximize inspection efficiency depending on the diameter of the cylindrical battery products C1, C2 and C3. In particular, the larger the diameter of the cylindrical battery product, the greater the visibility of defective areas.

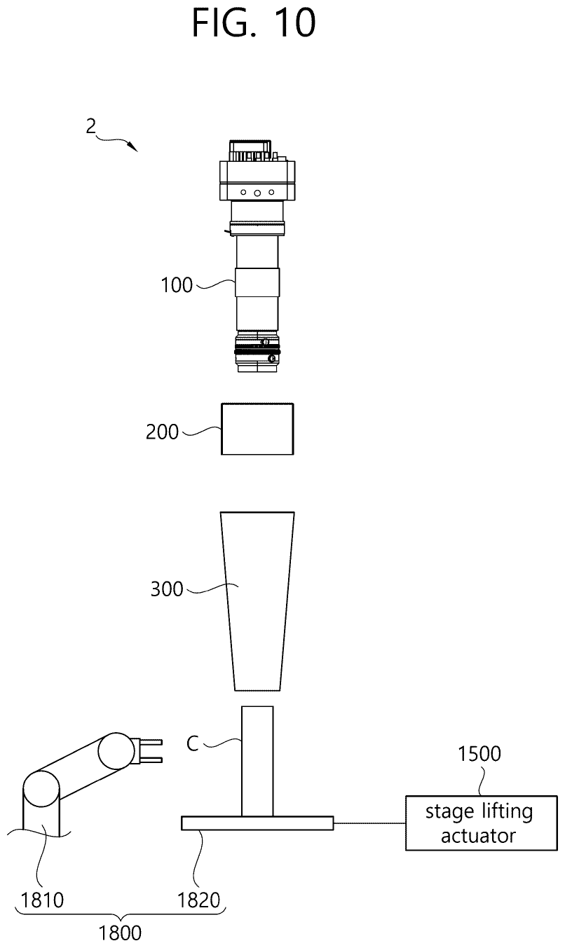

Below, an imaging device with a tiltable mirror for the internal surface of cylindrical battery products according to another embodiment of the disclosure will be described with reference to FIG. 10. To avoid redundant description, descriptions about parts identical or similar to those of the foregoing embodiment will be omitted. FIG. 10 is a conceptual diagram of an imaging device with a tiltable mirror for the internal surface of cylindrical battery products according to another embodiment of the disclosure.

Referring to FIG. 10, an imaging device 2 with a tiltable mirror for inspecting the internal surface of cylindrical battery products according to this embodiment of the disclosure may be different from that of the foregoing embodiment in a transfer module 1800 and a lifting module.

Specifically, according to this embodiment of the disclosure, the transfer module 1800 may include a robot transfer device 1810 and a stage 1820. The robot transfer device 1810 may be a robotic arm that operates to transfer the cylindrical battery product C, which has completed other inspections elsewhere, to the stage 1820. Because such devices are well-known in the art, a detailed description thereof will be omitted.

The stage 1820 is located at the imaging position and provides a space for the cylindrical battery product C to be seated. In this case, the stage 1820 may be structured to move up and down. In this embodiment, the lifting module may be provided as a stage lifting actuator 1500 that moves the stage 1820 up and down to be adjusted in height. The stage lifting actuator 1500 may be implemented with various structures for transmitting power to the stage 1820 based on a motor or an actuator.

According to this embodiment, by adjusting the height of the stage 1820 on which the cylindrical battery product C is seated, the distance between the cylindrical battery product C and one or more of the camera module 100, the coaxial lighting module 200, and the internal-surface reflection mirror module 300 can be adjusted corresponding to the cylindrical battery products C of various lengths.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

According to the embodiments of the disclosure, the effects are at least as follows.

A certain level of detection capability is maintained while enabling inspection of the internal surface of cylindrical batteries with a long length relative to the volume of an optical system. Accordingly, inspection of various types of batteries is enabled while minimizing a footprint required for equipment installation, thereby reducing manufacturers'burden on costs and space for the equipment installation.

By adjusting the angle of the mirror, the viewing angle of a camera is changed, thereby enabling inspection at a higher viewing angle as an inspection area approaches an upper portion of the internal surface. Therefore, superior detection capability is achieved for defects near the upper portion of the internal surface compared to conventional systems.

The effects of the disclosure are not limited to those described above, and various other effects are included in the foregoing description.

### REFERENCE NUMERALS

1, 2: imaging device with tiltable mirror for internal surface of cylindrical battery products
100: camera module
200: coaxial lighting module
300: internal-surface reflection mirror module
310: mirror angle adjuster
320: mirror
400: support
500: mirror lifting actuator
610: controller
620: detection sensor
700: camera lifting actuator
800, 1800: transfer module
900: lighting lifting actuator
1500: stage lifting actuator
1810: robot transfer device
1820: stage

What is claimed is:

1. An imaging device with a tiltable mirror for an internal surface of cylindrical battery products, the imaging device comprising:
a transfer module configured to transfer a cylindrical battery product with opened top side in an upright posture, to an imaging position;
a camera module positioned above the imaging position and configured to capture an image of the cylindrical battery product transferred to the imaging position; and
an internal-surface reflection mirror module positioned between the imaging position and the camera module and configured to reflect the internal surface of the cylindrical battery product,
the internal-surface reflection mirror module comprising:
a plurality of mirrors arranged around a height axis vertically passing through the imaging position; and
a mirror angle adjuster configured to adjust an angle formed by each of the mirrors with respect to the height axis.

2. The imaging device of claim 1, wherein each of the mirrors is provided to have a tilted shape to protrude further toward the height axis as being positioned closer to a lower end.

3. The imaging device of claim 2, wherein
the mirror angle adjuster is configured to adjust each of the mirrors from a first angle to a second angle or from the second angle to the first angle upon the cylindrical battery product being transferred to the imaging position, and
the first angle is an angle at which the mirror reflects a lower portion on the internal surface of the cylindrical battery product, and the second angle is an angle at which the mirror reflects an upper portion on the internal surface of the cylindrical battery product.

4. The imaging device of claim 3, further comprising a detector sensor configured to detect the cylindrical battery product transferred to the imaging position.

5. The imaging device of claim 1, further comprising a lifting module configured to change relative distances between the internal-surface reflection mirror module and the transfer module.

6. The imaging device of claim 5, wherein the lifting module comprises a stage formed to move up and down and configured to allow the cylindrical battery product located at the imaging position to be seated thereon.

7. The imaging device of claim 5, wherein the lifting module comprises a mirror lifting actuator configured to adjust the height of the internal-surface reflection mirror module.

8. The imaging device of claim 7, wherein the lifting module further comprises a camera lifting actuator configured to adjust the height of the camera module.

9. The imaging device of claim 1, further comprising a coaxial lighting module arranged between the internal-surface reflection mirror module and the camera module, and configured to irradiate light in a direction coaxial with an imaging direction of the camera module.
